(19) United States
(12) Patent Application Publication
(10) Pub. No.: US 2023/0098240 A1
(43) Pub. Date: Mar. 30, 2023

(54) APPARATUSES AND METHODS FOR CONTROLLING RATE OF PLAY AT A GAMING MACHINE

(71) Applicant: Everi Games Inc., Austin, TX (US)

(72) Inventors: Juan Carlos Mariscal, Lincolnwood, IL (US); Scott Donald Slomiany, Rolling Meadows, IL (US); Bradley A. Rose, Highland Park, IL (US); Robert Glahe, Woodridge, IL (US); Andrew Durre, Arlington Heights, IL (US); Brent Walker, Chicago, IL (US)

(73) Assignee: Everi Games Inc., Austin, TX (US)

(21) Appl. No.: 17/955,442

(22) Filed: Sep. 28, 2022

Related U.S. Application Data
(60) Provisional application No. 63/251,009, filed on Sep. 30, 2021.

(51) Int. Cl. G07F 17/32

(52) U.S. Cl. CPC G07F 17/3269; G07F 17/3262; G07F 17/3211; G07F 17/3209

(57) ABSTRACT

A method of controlling a gaming machine according includes causing a video display system of the gaming machine to display a number of activation icons. Each of the activation icons includes a respective activation value so that the number of activation icons define a activation value range from a minimum activation value to a relatively higher maximum activation value. The method further includes receiving a activation selection input that selects one of the activation icons to place the activation value included in the selected activation icon as a activation for an activation of the gaming machine. In response to the activation selection input and under control of a result generating processing system associated with the gaming machine, a result for the activation is obtained and, where the result is a winning result, the video display system is caused to display the result obtained for the activation selection input in a numerical prize graphic comprising a static numerical value.

### COPYRIGHT NOTICE

A portion of the disclosure of this patent document contains material that is subject to copyright protection. The copyright owner has no objection to the facsimile reproduction of the patent document or the patent disclosure as it appears in the U.S. Patent and Trademark Office patent files or records, but otherwise reserves all rights.

### CROSS-REFERENCE TO RELATED APPLICATION

Applicant claims the benefit, under 35 U.S.C. § 119(e), of U.S. Provisional Patent Application No. 63/251,009 filed Sep. 30, 2021, and entitled “Apparatuses and Methods for Controlling Rate of Play at a Gaming Machine.” The entire content of this provisional application is incorporated herein by this reference.

### TECHNICAL FIELD OF THE INVENTION

The invention relates to gaming machines and the control and operation of gaming machines, in particular, controlling the rate of play at a gaming machine. The present invention encompasses methods for controlling a gaming machine, gaming machines configured to effect the methods, and program products for configuring a gaming machine to effect the control methods.

### BACKGROUND OF THE INVENTION

Traditional gaming machines include both mechanical reel and video reel-type gaming machines, video poker gaming machines, and numerous other types of gaming machines that are available for play at casinos or other gaming establishments. Such gaming machines operate to ultimately display a game result for a given activation, and this game result may or may not be associated with a prize to be awarded to the player for the given activation. Various types of game operation and various types of interesting graphics and graphic effects, together with sound effects, have been developed in an effort to provide more entertainment value for players and thereby help maintain the players' interest.

Traditional reel-type gaming machines, both those having mechanical reels and those that display representations of reels on video displays, show a result for an activation of the gaming machine by spinning the reels and then bringing the reels to a stop to show a matrix of game symbols. Certain symbol combinations that may be shown in the matrix may be defined as winning combinations via a suitable paytable and correlate to a prize to be awarded to the player for the given activation of the gaming machine. Thus the presence of any of these predefined symbol combinations in the matrix after a spin of the reels indicates to the player any prize they have won for the given activation of the gaming machine. Beyond the basic spin of the reels to show a result, various anticipation reel spin effects may be performed, various reel respins may be conducted, and other types of bonus games added to the base game to present results to the player in an entertaining fashion.

While many players may enjoy the reel spins, various anticipation effects, and bonus games provided in response to an activation of the gaming machine, these prior methods for displaying results to the player all have the effect of slowing the rate at which the gaming machine may be played. There is an ongoing need in the gaming industry to provide gaming machines and gaming machine operation and control methods that maintain player interest and provide high entertainment value to encourage play, while enabling the player to play at their preferred rate of play without undue restriction resulting from the result presentation method.

### SUMMARY OF THE INVENTION

One object of the invention is to provide gaming machines and gaming machine control methods that are capable of rapidly displaying a result for an activation of the gaming machine as desired by the player and thereby capable of expanding a rate of play range.

Methods of controlling a gaming machine according to a first aspect of the invention include causing a video display system of the gaming machine to display a number of activation icons. This step as with each other step of causing the video display system to display a certain graphic or effect is performed under control of a display control processing system associated with the gaming machine. Each of the activation icons includes a respective activation value so that the number of activation icons define an activation value range from a minimum activation value to a relatively higher maximum activation value. Once the activation icons are displayed, the method includes receiving an activation selection input at the gaming machine through a player input system of the gaming machine. This activation selection input selects one of the activation icons to define the activation value included in the selected activation icon as the activation value in effect for an activation of the gaming machine. In response to the activation selection input and under control of a result generating processing system associated with the gaming machine, methods according to this first aspect of the invention include obtaining a result for the activation selection input. The result for the activation selection input is identified according to a result identification process corresponding to the activation value defined by the received activation selection input. Where the result for the activation selection input comprises a winning result, methods according to this first aspect of the invention include causing the video display system of the gaming machine to display the result obtained for the activation selection input in a numerical prize graphic. This numerical prize graphic comprises a static numerical value. Some embodiments may also include incrementing a player credit amount at the gaming machine by the static numerical value.

An example of a numerical prize graphic in methods according to this first aspect of the invention comprises a graphic showing the numerical value “100.” This example includes three static digit places, the three from left to right showing respectively the digits “1,” “0,” and “0.” As another example, a numerical prize graphic may comprise a graphic showing the value “15” in which case the graphic includes two static digit places “1” and “5.” It should be appreciated that numerical prize graphics according to this aspect of the invention are not limited to two and three static digit places as in these examples but may include any number of one or more static digit places.

The designation “static numerical value” as used in this disclosure and the accompanying claims means a value made up of one or more digit places that substantially continuously show a numerical value. For example, each digit place may show a digit between 0-9 during a prize display period extending from an initial display point in time at which the numerical prize graphic is first displayed in response to an activation and winning result, to a final display point in time following the initial display point in time at which point the numerical prize graphic is removed from the display device. Thus a static numerical value includes both a value where each included digit is entirely stationary during the prize display period and a value where one or more of the included digits moves in a vertical and/or horizontal direction or moves in some other fashion while substantially continuously showing the respective digit. A static numerical value also includes a value in which one or more of the digits included in the value disappear intermittently, either in an imperceptible way such as at a display refresh rate over approximately 50 Hz or in a perceptible way where the digit appears to flash but the value of the digit remains constant over the prize display period. A static numerical value does not encompass a set of one or more physical or video-generated spinning wheels or reels bearing numerical values. Thus methods according to this first aspect of the invention may dispense with any reel or wheel spin graphic and thereby dispense with the delay required to display the reel or wheel spin graphic to the player.

Additional aspects of the invention include gaming machines and program products for implementing methods according to the first aspect of the invention. A gaming machine according to a second aspect of the invention includes a video display system, player input system, at least one processor, and at least one memory device storing instructions executable by the at least one processor. In particular, the instructions are executable to cause the video display system to display the activation icons, to receive the activation selection input, obtain the result for the activation selection input, and cause the display system to display a winning result, all as described above in connection with methods according to the first aspect of the invention.

A program product according to a third aspect of the invention comprises one or more non-transitory computer readable data storage devices storing program code. The program code includes starting graphic, activation selection, result assignment, and result display. The starting program code is executable by at least one processor to cause a video display system of a gaming machine to display a number of activation icons as described above. The activation selection program code is executable by the at least one processor to receive the activation selection input from a player input system of the gaming machine, and the result assignment program code is executable by the at least one processor to obtain the result for the activation selection input as described above in connection with methods according to the first aspect of the invention. The result display program code is executable by the at least one processor to cause the video display system to display, via the numerical prize graphic, the winning result obtained for the activation selection input as described above in connection with the methods.

In accordance with any of the above-described aspects of the invention both the activation icons and the resulting numerical prize graphic may be displayed on a primary display device of the video display system, or at least the same display device.

Regardless of what display device is used to display the activation icons and what display device is used to display the numerical prize graphic, the activation icons or at least some of them, may each comprise a representation of an exterior of an enclosure (such as a box) and the numerical prize graphic may include a representation of opening the enclosure. In these implementations the numerical prize graphic may include an initial sequence followed by a value display sequence. The initial sequence may comprise a representation of at least two additional enclosures in a closed state emerging from the opening of the enclosure, while the value display sequence may comprise a representation of each of the additional enclosures opening to display at least one respective static numerical value for each of the additional enclosures. In other implementations the numerical prize graphic may comprise just a value display sequence with the representation of the exterior of an enclosure comprising the activation icon changing to the numerical prize graphic with or without a representation of the enclosure opening to reveal the numerical prize graphic.

In implementations according to any of the above-described aspects of the invention, the number of activation icons may include a first set of activation icons and a second set of activation icons. Each activation icon of the first set of activation icons may include a respective activation value in a first activation range and each activation icon of the second set of activation icons may include a respective activation value in a second activation range that is non-overlapping with the first activation range. In these implementations, the activation selection input needed may depend on the set of activation icons in which the selected icon is included. In particular, when selecting an activation icon from the first set of activation icons, the activation selection input may consist of a single player interaction with the player input system. However, when selecting an activation icon from the second set of activation icons, the activation selection input may consist of at least two player interactions with the player input system. In this way, a set of activation icons defining large activation values may require confirming player interactions before activating the gaming machine to produce a result. Where two interactions with the player input system are required for example, a first interaction may comprise an activation icon designation input received from the player through the player input system to designate a respective one of the activation icons, and a second interaction may comprise an activation icon confirmation input received from the player through the player input system to confirm the designated one of the activation icons. Also, in response to the activation icon designation input, the gaming machine display control processing system may cause an activation amount notice graphic to be displayed at the video display system, and then the activation icon confirmation input may comprise an input from within the area of the activation amount notice graphic or the activation icon.

In implementations according to any of the above-described aspects of the invention, the number of activation icons can be in different sets with each set associated with a different non-overlapping activation value range. In these implementations the icons in each set may be identifiable as included in that set by some visual characteristic such as color for example.

Some implementations under any of the above-described aspects of the invention may allow a player at the gaming machine to control a characteristic of the numerical prize graphic. For example, a credit display control input received at the gaming machine through a control separate from any of the activation icons may place the gaming machine in an extended display state for a given activation selection input. When in this state, incrementing a player credit value in response to a numerical prize value may include incrementing the player credit value at a desired rate over a credit incrementing period to ultimately show the final value after addition of the static numerical value.

In implementations under any of the above-described aspects, some displayed activation icons may be associated with a first predefined characteristic while other of the displayed activation icons may be associated with a second, different predefined characteristic. In these implementations, the result obtained for a given activation selection input may be shown in a first type of graphic display for an activation icon associated with the first predefined characteristic while the result may be shown in a different, second type of graphic display for an activation icon associated with the second predefined characteristic. For example, the predefined characteristic may be an activation value over some threshold value and the numerical prize graphic shown for that characteristic may have a relatively longer duration as compared to activation icons associated with an activation value below the threshold. The longer duration display may be controlled to build up suspense and also effectively slow the possible rate of play.

These and other aspects, advantages, and features of the invention will be apparent from the following description of representative embodiments, considered along with the accompanying drawings.

### BRIEF DESCRIPTION OF THE DRAWINGS

FIG. 1 is an isometric view of a gaming machine that may be used for some implementations of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a flow chart showing a process in accordance with an example embodiment of the present invention.

FIG. 5 is a representation of a graphic presentation in an implementation of the present invention at a point in time after the gaming machine presenting the graphic has been initialized and a number of activation icons have been displayed preparatory to receiving activation selection inputs initiated by a player.

FIG. 6 is a representation of a graphic presentation comprising a display produced after the presentation shown in FIG. 5 in response to receipt of an activation selection input.

FIG. 7 is a timing diagram showing potential temporal relationships between activation selection inputs and display of results in response such inputs.

FIG. 8 is a representation of an example activation icon that may be used in implementations of the present invention for high-value activations.

FIG. 9 is a representation of the activation icon shown in FIG. 12 after an initial player interaction with the activation icon.

FIG. 10 is a representation of a graphic presentation produced in the implementation shown in FIG. 5, but at a point in time after that shown in FIG. 6.

FIG. 11 is a representation of a graphic presentation produced in the implementation shown in FIG. 5, but at a point in time after that shown in FIG. 10.

FIG. 12 is a representation of a graphic presentation produced in the implementation shown in FIG. 5, but at a point in time after that shown in FIG. 11.

FIG. 13 is a representation of a graphic presentation produced in the implementation shown in FIG. 5, but at a point in time after that shown in FIG. 12.

FIG. 14 is block diagram showing software data structures and devices that may be employed in an implementation of a result generating processing system within the scope of the present invention.

FIG. 15 is a representation of a graphic presentation in an alternate implementation of the present invention.

FIG. 16 is a representation of a graphic presentation comprising a display produced after the presentation shown in FIG. 15 in response to activation range change selection.

FIG. 17 is a representation of a button panel that may be used with implementations of the present invention.

FIG. 18 is a representation of a graphic presentation similar to that shown in FIGS. 15 and 16 as modified in response to a player selection of one of the high-level activations.

FIG. 19 is a representation of a portion of a graphic presentation similar to that shown in FIG. 15, but with a different activation range.

### DESCRIPTION OF REPRESENTATIVE EMBODIMENTS

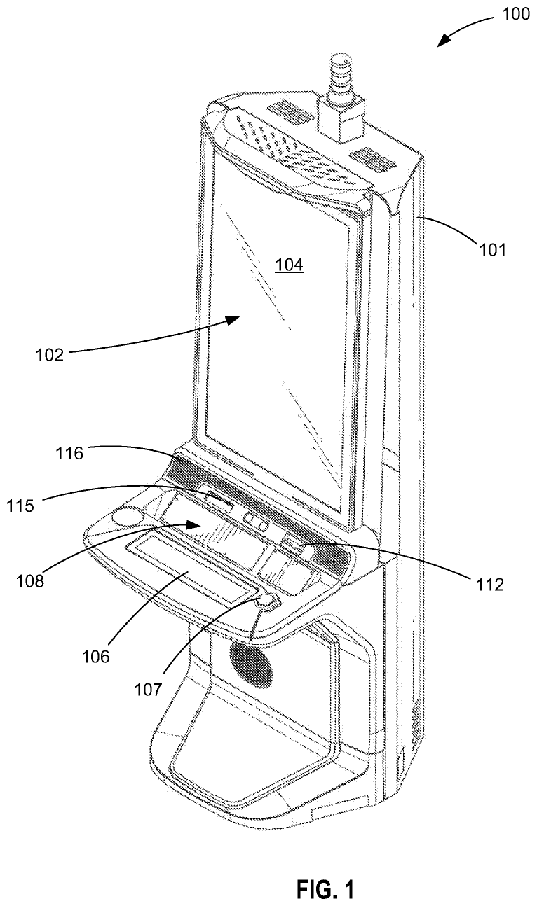

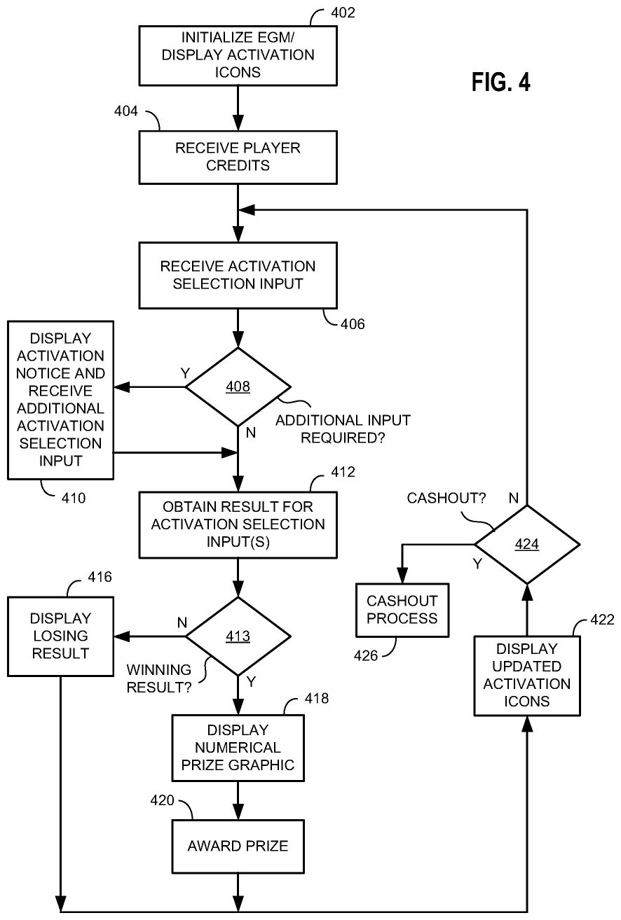

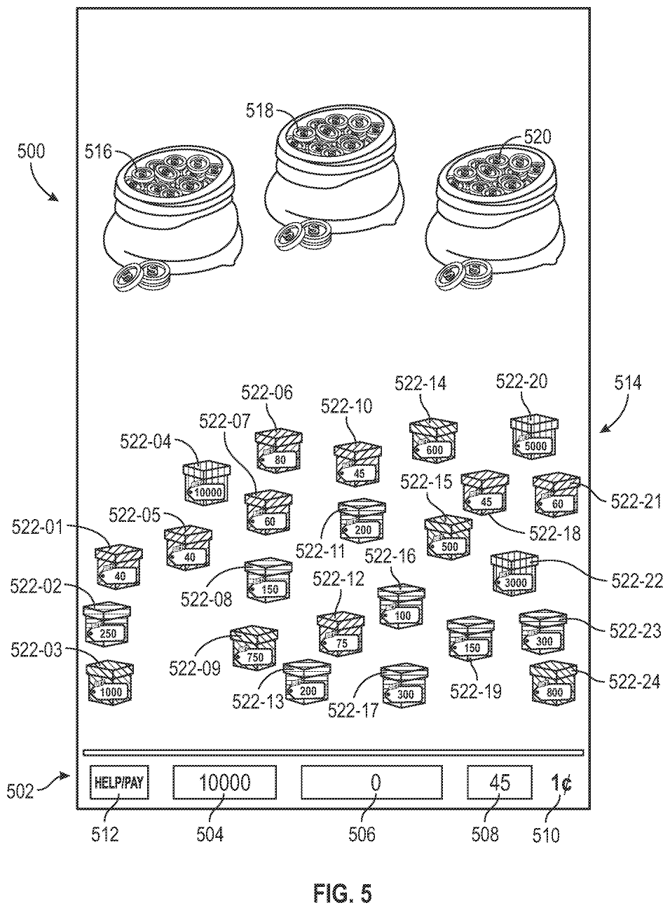

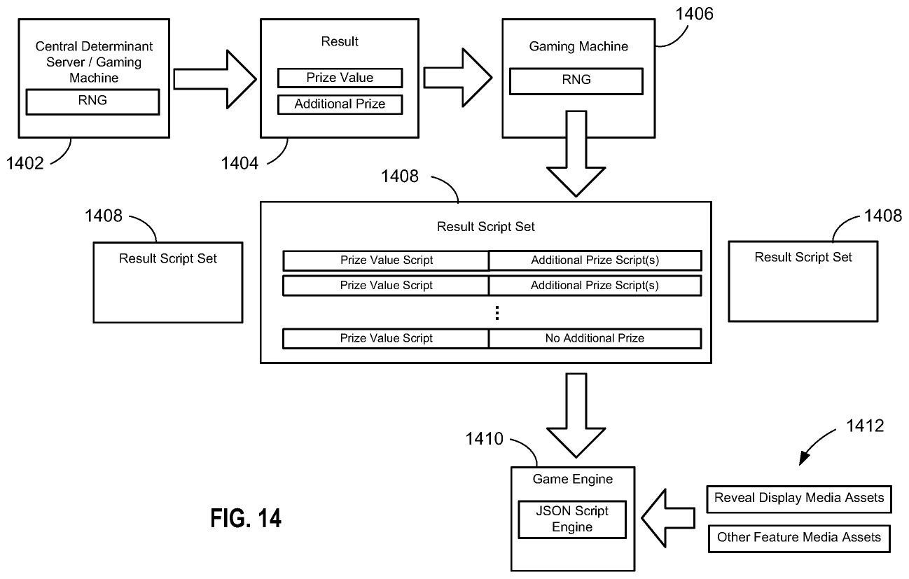

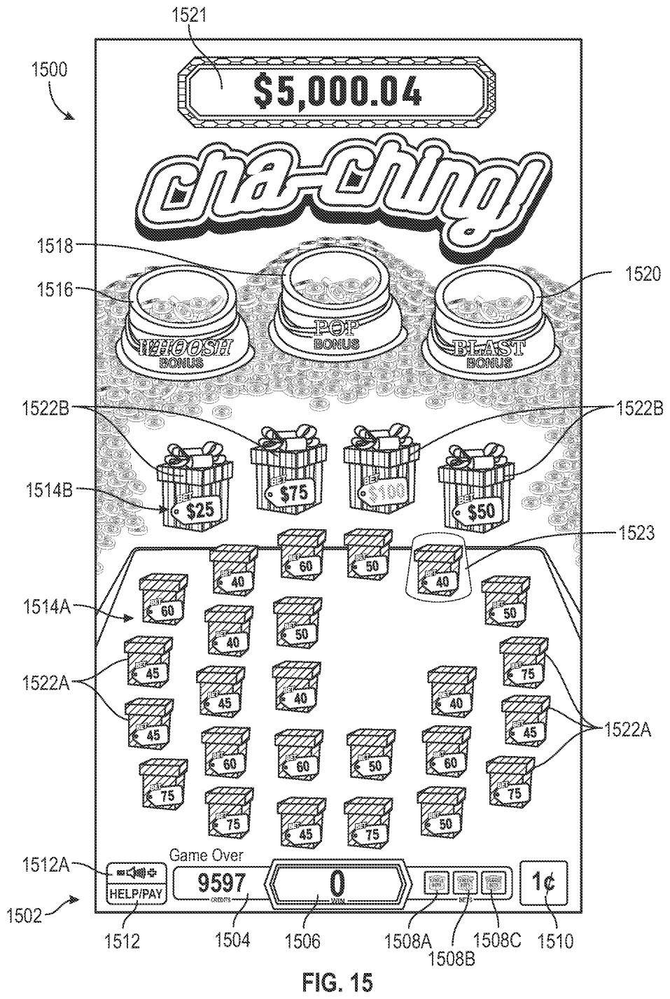

FIGS. 1-3 will be used to describe example gaming machines and gaming networks in which aspects of the present invention may be implemented. FIG. 4 will be used to describe example methods of controlling a gaming machine according to various implementations of the present invention. FIGS. 5-13 will be referenced below to describe example implementations of prize display processes and systems in accordance with the present invention. FIG. 14 will be referenced below to describe certain software and data structures that may be employed in implementations of the invention. FIGS. 15-19 will be referenced to describe certain alternate implementations in accordance with aspects of the present invention.

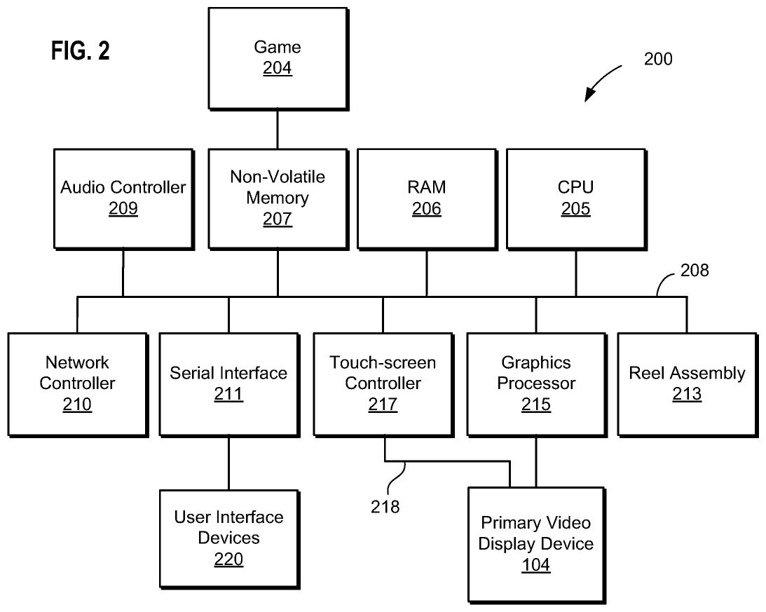

Referring to FIG. 1, gaming machine 100 includes a cabinet 101 having a front side generally shown at reference numeral 102. A primary video display device 104 is mounted in a central portion of the front side 102, and a touch-screen button panel 106 is positioned below the primary video display device. Gaming machine 100 may include additional smaller auxiliary display devices (not shown) and/or other devices in the area shown generally at 108. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display graphics associated with a prize presentation in accordance with aspects of the present invention either as a base game or bonus game. As will be described further below in connection with FIG. 2 and elsewhere, it is also possible for gaming machines within the scope of the present invention to include mechanical elements such as mechanical reels. Generally, the display device or display devices of the gaming machine, through which prize presentations may be shown in accordance with the present invention may be described in this disclosure and the accompanying claims as a “display system” regardless of whether the gaming machine in question includes one or more video display devices showing graphic elements such as reel simulations, or physical reels, or combinations of the two. The term “display” when not used to qualify a term such as “device,” “apparatus,” or “system,” for example, will be used in this disclosure and accompanying claims to refer to an arrangement of one or more graphic elements shown by a display device or to the act of displaying such graphic elements by a display device unless explicitly indicated otherwise.

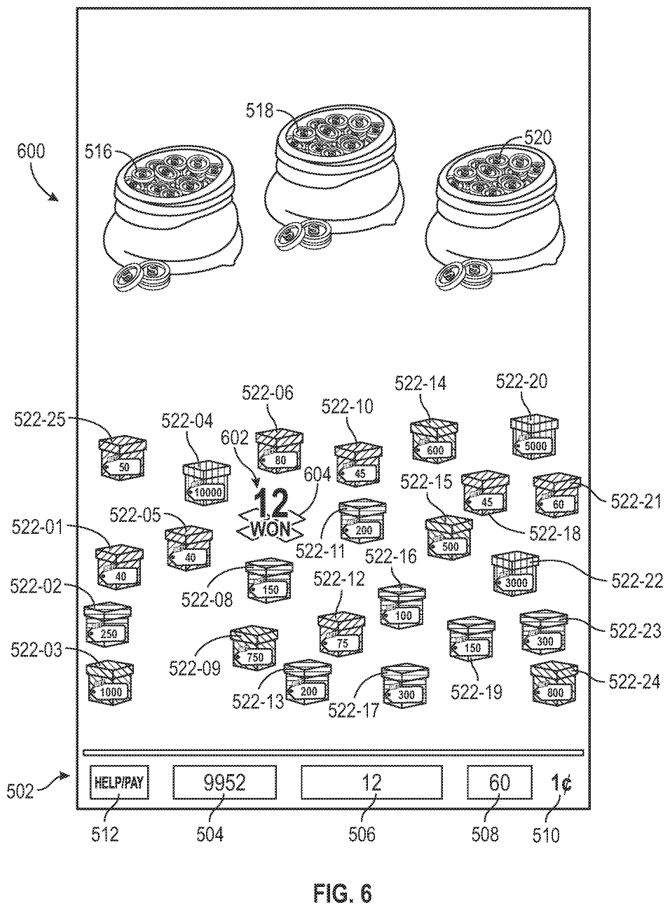

The gaming machine 100 illustrated for purposes of example in FIG. 1 also includes a mechanical control button 107 mounted adjacent to touch-screen button panel 106. This control button 107 may allow a player to make a play input to start a play in a game conducted through gaming machine 100. However, as noted further below in the context of the flow diagram of FIG. 4 and the example displays of FIGS. 5 and 6 for example, it may not be necessary for the player to actuate the control button 107 to start a play in a game conducted through the gaming machine 100. Regardless of how plays in the game are initiated, virtual buttons included (but not shown in this view) on button panel 106 or other physical buttons or controls (not shown) may allow a player to make other selections or inputs at the gaming machine preparatory to or during the play of a game at the gaming machine. Such buttons or controls on button panel 106 or on the deck supporting that panel may or may not be redundant to controls provided elsewhere on the gaming machine, such as virtual controls presented on display device 104. Touch-screen button panel 106 may also be used in implementations of the present invention to allow the player to control a cursor that may be displayed on another display device such as display device 104. Other forms of gaming machines through which the invention may be implemented may include switches, joysticks, trackballs, or other mechanical input devices in addition to the virtual buttons and other controls implemented on touch-screen button panel 106 or other display device on gaming machine 100. The player interface devices that receive player inputs in the course of a game played through the gaming machine, such as controls to select an activation amount for a given play, controls to enter a play input to actually start a given play in the game, or controls to allow a player to make other player inputs in a game controlled according to the present invention, may be referred to generally as a “player input system.”

It will be appreciated that gaming machines may also include a number of other player interface devices in addition to devices that are considered player controls for use in entering inputs in the course of a particular game. Gaming machine 100 also includes a currency/voucher acceptor having an input ramp 112, a voucher/receipt printer having a voucher/receipt output 115, and a player card reader (not shown in the view of FIG. 1). Numerous other types of player interface devices may be included in gaming machines that may be used to implement embodiments of the present invention.

Gaming machine 100 may also include a sound system to provide an audio output to enhance the user's playing experience. For example, illustrated gaming machine 100 includes speakers behind grille 116 that may be driven by a suitable audio amplifier (not shown) to provide a desired audio output at the gaming machine.

FIG. 2 shows a logical and hardware block diagram 200 of gaming machine 100 that includes a processor (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 (the display device 104 being mounted on cabinet 101 as shown in FIG. 1). Graphis processor 215, or another graphics processor included in the gaming machine but not shown in this diagram, may also provide a suitable video output to other video display devices included on the gaming machine such as touch screen button panel 106 for example. As shown in FIG. 2, gaming machine 100 also includes a touch screen controller 217 connected to system bus 208. Touch screen controller 217 is also connected via signal path 218 to receive signals from a touch screen element associated with primary video display device 104 or touch-screen button panel 106 or both. It will be appreciated that the touch screen element itself typically comprises a thin film that is secured over the display surface of the respective display device such as the display device of touch-screen button panel 106 in FIG. 1. The touch screen element itself is not illustrated or referenced separately in the figures. The present invention is not limited to any particular touch-screen technology.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured for use in a gaming environment. These elements may be mounted on (or connected to) a motherboard and housed in a personal computer housing that itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch-screen controller such as touch screen controller 217, the touch-screen controller may not be connected on system bus 208, but instead include a serial communications line to serial interface 211 (a USB controller for example). It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus or bus configured according to some other expansion bus standard. System bus 208 is shown in FIG. 2 merely to indicate that the various components are connected in some fashion for communication with CPU 205 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 205 or graphics processor such as 215 at the gaming machine, and may instead rely on one or more remote processors. Thus unless specifically stated otherwise, the designation “gaming machine” is used in this disclosure and the accompanying claims to designate a system of devices that operate together to provide the indicated functions. A “gaming machine” may include a gaming machine such as gaming machine 100 shown in FIGS. 1 and 2, that is itself a system of various components, and may also include one or more components remote from a gaming machine cabinet (that is, cabinet 101 in FIG. 1). As used herein, the designation “gaming machine” encompasses both a stand-alone gaming machine and a gaming machine (that is, the part housed in a cabinet such as cabinet 101 in FIG. 1) along with one or more remote components for providing various functions (such as identifying prizes for a given play and controlling result display graphics, and performing other operations described below in connection with the example process shown in FIG. 4).

It will also be appreciated that graphics processors are also commonly a part of modern computer systems. Although separate graphics processor 215 is shown for controlling primary video display device 104, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices. While the large display device 104 is particularly suited for showing displays in accordance with some implementations in accordance with aspects of the present invention, the display device area may be arranged differently than the portrait orientation shown or divided across multiple discrete display devices within the scope of the present invention.

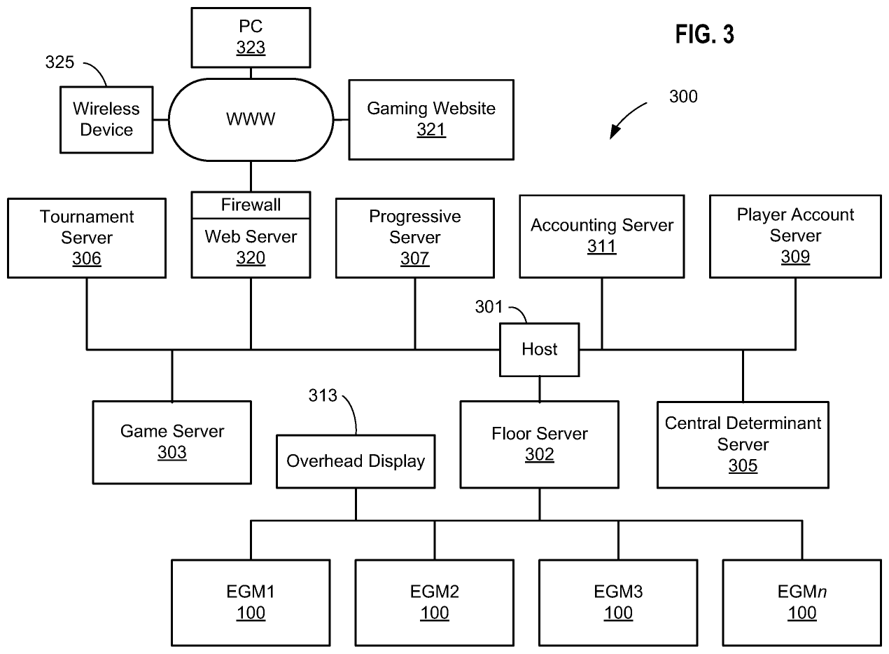

In the illustrated gaming machine 100, CPU 205 executes software, that is, program code, that ultimately controls the entire gaming machine including the receipt of player inputs and the presentation of the graphics or information displayed according to the invention through the display devices 104 and 106 associated with the gaming machine. In particular, CPU 205 may execute starting graphic program code, activation selection program code, result assignment program code, result display program code, and credit control program code as described further below in connection with FIGS. 4 and 14 as well as the example graphic displays. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software (program code) prior to loading into random access memory 206 for execution, or for programs and program assets not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, that may comprise an Intel® or AMD® processor for example, these special purpose processing devices may not employ operational program code to direct the various processing steps.

The example gaming machine 100 is shown in FIG. 2 as including user interface devices 220 (part of a player input system) connected to serial interface 211. These user interface devices may include various player input devices such as mechanical buttons, virtual buttons shown on touch-screen button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine that may present results in accordance with aspects of the present invention may also include mechanical reels. For example, a number of sets of mechanical reels (or a mechanical wheel) may be provided in addition to primary display device 104 to show results in bonus games or other games in addition to the results shown as described for example in FIGS. 5 and 6. Alternatively, mechanical reels may be included in the gaming machine behind a light-transmissive video display panel. Mechanical reels may also include one or more video display devices in place of a static reel symbol strip and thus be capable of conducting single-symbol reel spin simulations for one or more game symbol locations. In any case, the mechanical reels represent a display device for displaying various game symbols in the course of controlling the gaming machine. Although the invention is not limited to any particular mechanical reel arrangement or control system, mechanical reels may be controlled conveniently through serial communications to a reel controller that provides instructions for a respective stepper motor for each reel or wheel. Thus some embodiments of the present invention that employ mechanical reels may use a serial interface device such as serial interface 211 to control communications with the reel assembly, and may not include a direct bus interconnection as indicated by FIG. 2.

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead display devices 313 may be operatively connected so that the overhead display device or display devices may mirror or replay the content of one or more displays of gaming machines 100. For example, the primary display content for a given gaming machine 100 (including a base game portion and/or bonus features according to the present invention) may be transmitted through network controller 210 to a controller associated with the overhead display device(s) 313. In the event gaming machines 100 have cameras installed, the respective player's video images may be displayed on overhead display device 313 along with the content of the player's gaming machine display device.

The example gaming network 300 shown in FIG. 3 includes a host server 301 and floor server 302, that together may function as an intermediary between floor devices such as gaming machines 100 and back-office devices such as the various servers described below. Game server 303 may provide server-based games and/or game services to network connected gaming devices such as gaming machines 100. Central determinant server 305 may be included in the network to identify or select lottery, bingo, or other centrally determined game results and provide the result information to networked gaming machines 100 that present the games or game results to players.

Tournament server 306 may be included in the system for controlling or coordinating tournament functions. These functions may include maintaining tournament player scores and ranking during the course of tournament play, and communicating this information to the various gaming machines 100 participating in the tournament. Tournament server 306 may also function to enroll players in tournaments, schedule tournaments, and maintain the time remaining in the various tournaments.

Progressive server 307 may maintain progressive pools for progressive games that may be available through the various gaming machines 100. In some implementations, progressive server 307 may simply receive communications indicating contribution amounts that have been determined by processes executing at the various gaming machines 100 or elsewhere in the gaming network. Alternatively, progressive server 307 may perform processes to determine the contribution amounts for incrementing the various progressive pools that may be maintained. Progressive server 307 may also periodically communicate current pool values back to the various gaming machines 100, and may participate in communicating awarded progressive prize amounts to the gaming machines and making adjustments to the progressive prize pools accordingly. In some implementations, progressive server 307 may also determine or participate in determining when a progressive prize triggering event occurs.

Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 that may be hosted through web server 320 and may be accessible by players via the Internet. One or more games may be displayed as described herein and played by a player through a personal computer 323 or handheld wireless device 325 (for example, an Android® operating system smart phone, Apple® iPhone® smart phone, personal digital assistant (PDA), iPad® or other tablet computer, etc.). To enter website 321, a player may log in with a user name that may, for example, be associated with the player's account information stored on player account server 309. Once logged in to website 321 the player may play various games on the website, including games according to the invention. Also, website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network that may facilitate prize presentations according to aspects of the present invention, and is not intended to be limiting in any way. Gaming machines controlled according to aspects of the present invention are not limited to use with gaming networks such as network 300.

FIG. 4 shows an example process of controlling a gaming machine to provide prize presentations in accordance with aspects of the present invention. The illustrated method includes initializing the EGM (such as gaming machine/EGM 100 shown in FIGS. 1 and 3). Initializing the gaming machine as indicated at process block 402 in FIG. 4 may comprise a boot-up process to place the gaming machine in a state in which it may perform the other steps set out in FIG. 4. In this particular example process, the operations at process block 402 further include displaying activation icons on a suitable display device of the gaming machine such as display device 104 in FIG. 1. The activation icons displayed according to process block 402 in FIG. 4 will be described further below in connection with FIGS. 5 and 6.

The process at FIG. 4 also includes receiving a player credit input as shown at process block 404. This credit input may comprise any suitable input to place credits on the gaming machine to allow the player to make activations as will be described further below. For example, in a ticket-in-ticket-out gaming system, the credit input may be made by inserting a computer readable ticket into a suitable ticket reader at the gaming machine. The credit value read from the inserted ticket is then registered at the gaming machine and commonly shown on a suitable credit meter to show the credits available for activations at the gaming machine. Alternatively or in addition to inserting a ticket, a gaming machine in accordance with the present invention may be configured accept currency as a credit input. However, credits received as indicated at process block 404 may or may not correlate to monetary value. For example, credits received as indicated at process block 404 may correlate to player points that do not have any monetary value. In this case, the activation value placed in accordance with the present invention may not be associated with a monetary value.

After the activation icons are displayed and player credits are received at the gaming machine, the method illustrated in FIG. 4 includes receiving an activation selection input as shown at process block 406. In this example implementation, more than a single activation selection input may be required in order to make a complete activation selection input. Thus the process includes determining if an additional input is required as indicated at decision block 408. If an additional input is required, the process branches to process block 410. At this point the process may display an activation notice indicating an additional input is required and then include receiving the additional activation selection input. Once the additional activation selection input is received or if no additional input is required as indicated by negative outcome at decision box 408, the process proceeds to obtain a result for the activation selection input or inputs as shown at process block 412. In the event the result for the activation selection inputs is a losing result, that is, provides no payout value for the activation, the process branches from decision box 414 to display the losing result is indicated at process block 416. However, if the result obtained at process block 412 comprises a winning result, that is, includes a payout value, the process proceeds to display a numerical prize graphic to reveal that result to the player as indicated at process block 418. The process also includes awarding the prize associated with the result as indicated at process block 420. The activation icon display may be updated as indicated at process block 422 and then a determination can be made as to whether the player has activated a cash out device at the gaming machine. In the event no cash out input is detected as indicated by a negative outcome at process box 424, the process loops back to await another activation selection input at process block 406. Otherwise, if a cash out request (via a suitable player control at the gaming machine) is detected, the process proceeds to the cash out procedure as indicated at process block 426. Further aspects of the various process steps shown in FIG. 4 and variations will be described further below in connection with the examples of FIGS. 5-13.

The example process shown in FIG. 4 assumes that the prize presentation arrangement according to the present invention is a standalone process, separate from any other game presentation. It will be appreciated, however, that prize presentation according to the present invention is not limited to a standalone process. Rather, displaying activation icons and the process steps 406-422 shown in FIG. 4 may be part of an overall game process that may include additional features or parts. For example, the process steps 406-422 may comprise a bonus game or feature that is reached after the conduct of a base game portion or another bonus feature. Alternatively, process steps 406-422 may represent a base game portion after which additional portions of an overall game are presented, each including a result that may or may not be associated with the prize awarded for a given activation selection input at process block 406.

FIGS. 5 and 6 will now be referenced to describe a series of displays produced in accordance with an embodiment of the present invention to accept activations and reveal prize results. FIG. 5 shows a display 500 that may be produced on a display device such as display device 104 shown in FIG. 1 for gaming machine 100. Display 500 includes a player information section shown generally at 502, including a number of windows providing information to the player. Example play information section 502 includes a credit meter window 504 for displaying a credit value for the player and available for activations at the gaming machine, and a win meter window 506 for displaying the credit value of a win for a current activation of the gaming machine. Example display 500 shows a credit value of 10,000 credits at credit meter window 504 and 0 credits at win meter window 506, indicating a 0-credit result for the last activation placed at the gaming machine. Player information section 502 further includes a bet value window 508 in this case showing a bet of 45 credits for the last activation placed at the gaming machine, and a game denomination window 510 indicating a denomination of 1 cent per credit. Player controls may be accessed through a player control virtual button 512 included in display 500. Selecting the player control button 512 may cause the gaming machine to present a player control window (not shown) over some or all of the area of display 500, and providing help information and/or various controls to change aspects of the presentation from that shown in FIG. 5, and to change other aspects of gaming machine operation such as sound volume for example.

Beyond the player information section 502, display 500 includes an activation icon area shown generally at 514 and three bonus game indicators 516, 518, and 520. The activation icon area 514 includes a number of different activation icons 522-01 through 522-24. In this case each activation icon is represented by a box (that is, an enclosure) together with a label that indicates an activation amount. The activation icon 522-06 for example has a label indicating a value of 80 referring to an 80-credit activation associated with that icon. Activation icon 522-10 for example shows an activation value of 45 credits. It is apparent from display 500 that the size of the activation icon area 514 and the size of the various activation icons allows a large number of activation icons to be displayed concurrently. In this particular example 24 different activation icons are visible with spaces in the field of activation icons to accommodate additional activation icons as will be described further below. In the display 500, the activation icons vary from a minimum activation shown as 40 credits at activation icons 522-01 for example, to very large activations such as a 10,000-credit activation associated with activation icon 522-04 (the maximum activation in this case). In this particular example, the activation icons are separated into four tiers based on the value associated with the particular activation icon. Activation icons associated with an activation value less than 100 credits may be considered low-tier activation icons while activation icons associated with an activation value of 100 credits to less than 500 credits may be considered mid-tier activation icons. Activation icons associated with an activation value from 500 to 1000 credits may be considered high-tier activation icons, while activation icons associated with an activation value over 1000 credits may be considered ultra-high-tier activation icons. Activation icons in each of these different tiers may share a graphic characteristic, such as a distinctive color, to allow a player and spectators to more easily identify the respective activation icons and their relative activation value. Although the example display 500 includes the activation icons of different values mixed together over the entire display area 514, other implementations of the invention may segregate the activation icons into groups each having an associated activation range.

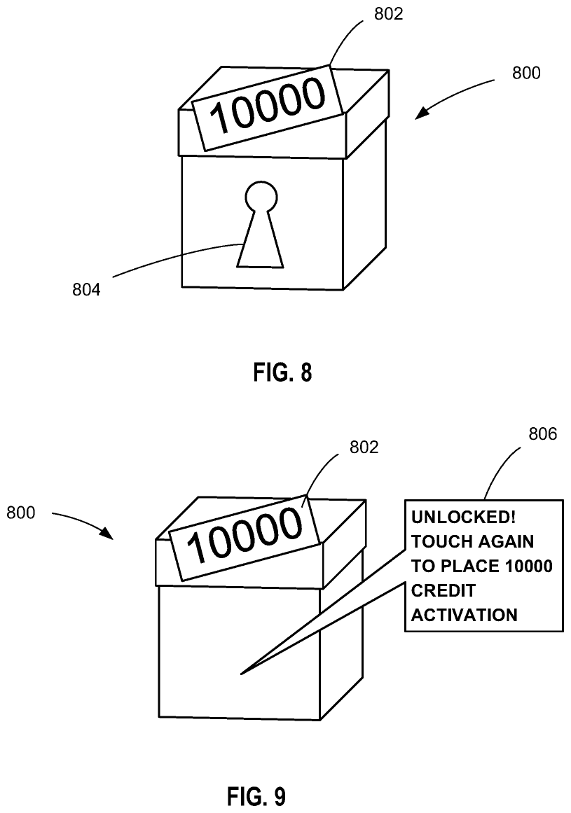

Each of the activation icons shown in the display 500 represents a control that may be selected to activate the gaming machine at the activation value indicated by that activation icon. In some implementations of the invention, simply touching or otherwise selecting a respective activation icon (via a cursor and cursor control arrangement for example) places the activation value associated with that activation icon as an activation for a play in the gaming machine. As indicated in the process shown in FIG. 4, implementations of the invention may require additional player inputs at least for some activation icons. Examples of activation icons requiring additional inputs will be described below in connection with FIGS. 8 and 9.

FIG. 6 shows a display 600 at a point in time after the display shown in FIG. 5. In particular, display 600 shows a state of the gaming machine at which activation icon 522-07 in FIG. 5 has been selected in accordance with the process shown from process block 406 in FIG. 4. In this example of display 600, the result obtained (process block 412 in FIG. 4) for the activation selection input comprises a winning result that is shown by a numerical prize graphic 602 shown in the same location of the display area 514 where the activation icon 522-07 was previously shown. The example of FIG. 6 shows that the numerical prize graphic 602 includes a static numerical value of 12, representing a prize value of 12 credits. This particular example also shows a textual element 604 indicating that the 12 credits have been won as a result of the activation placed by selecting the activation icon 522-07 (shown in FIG. 5). Both the numerical prize graphic 602 and the textual element 604 in the example of FIG. 6 are displayed over a representation of an open box. The process of displaying the numerical prize value may include an animation of the box representing the activation icon opening in some fashion to produce the open box representation shown in FIG. 6. In display 600, the win of 12 credits also shows in the win meter 506 and the player credit value has been decremented by the activation value associated with activation icon 522-07 (60 credits as shown in FIG. 5) and incremented by 12-credit win value. In order to keep the time required for the 12-credit win result to be kept to a minimum, the gaming machine may by default show the addition of 12 credits in a single operation in both the win meter 506 and credit meter 504. Alternatively, the gaming machine may show this incrementing of credits sequentially in an extended period perhaps one credit at a time as is common in gaming machines. Whether the prize is “banged up” sequentially over a period of time on the win meter and credit meter or as a single addition operation on each meter may be player selectable via a suitable player control.

In the event the result obtained for the activation selection input (at block 412 in FIG. 4 for example) is a losing result, that is, if there is no prize value associated with the result, implementations of the invention may display the losing result in any suitable fashion. In the implementation shown in FIGS. 5 and 6, for example, the losing result may be displayed by showing an animation of the box associated with the selected activation icon opening similarly to a winning result, but with no numerical prize graphic. Thus in the example of FIG. 6, a losing result may be shown (as at 416 in FIG. 4) similarly to the winning result but with no numerical value shown, only the opened box. Alternatively, a losing result may be displayed similarly to a winning result but with “0” shown instead of a numerical prize value. As a further alternative, a text label indicating a losing result may be displayed together with the open box or in lieu of the open box.

It will be appreciated that by showing the result for the activation as a numerical prize graphic made up of a static numerical value, the result for the activation may be shown very quickly in response to the activation. Also, since the activation may be placed in some cases by a single selection input, game play may proceed very quickly should the player desire to play in that fashion. Thus showing the result associated with an activation in accordance with the present invention has the effect increasing the rate of play possible at the gaming machine.

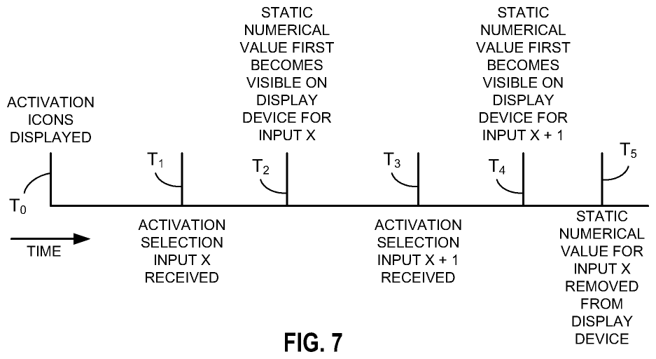

FIG. 7 shows a timing chart indicated the relative timing between the various operations according to aspects of the present invention. In the example of FIG. 7, time T₁ indicates a point in time at which an activation selection input is received (at 406 in FIG. 4) in the process after activation icons have been displayed. Time T₂ indicates a point in time at which the static numerical value first becomes visible on the display device for the input at T₁. The time from T₁ to T₂ may be very short, on the order of a second or less for example. As a practical matter the time between T₁ and T₂ is limited only by the time needed to obtain the result in the particular gaming system and the time needed to drive the display device to show the static numerical value included in the numerical prize graphic. These process steps (408 to 418 in FIG. 4) may be performed very quickly in the different gaming environments in which the present invention may be implemented as described below in connection with FIG. 14. In any event, once the static numerical value of the numerical prize graphic (e.g., 602 in FIG. 6) is shown on the display device, FIG. 7 indicates that the static numerical value may continue to be shown until time T₅. In the meantime, FIG. 7 shows that a second activation selection input, input X+1, is received at time T₃ and then the static numerical value for that numerical prize graphic first becomes visible to show the result for that second activation selection input X+1 at time T₄. In this example timeline, the subsequent activation for input X+1 and the display of the static numerical value to show the result occur before the static numerical value for the earlier activation selection input, input X, is removed from the display device. The timing between T₂ and T₅ represents a display period in which the result for the activation selection input (received at 406 in FIG. 4 at time T₂ in FIG. 7) is displayed to the player via the display device. Depending upon how this display period for a numerical prize graphic is set for a given implementation, a display such as 600 may show two as indicated in FIG. 7 or even more numerical prize graphics on the display device(s) at the same time, each for a different activation selection input.

In other implementations of the invention, the process may be controlled to prevent this overlap of numeric prize graphics or a certain degree of overlap in accordance with the invention. For example, in the situation indicated in FIG. 7 where there are already two numeric price graphics being displayed concurrently, the activation icons may be controlled to not accept a further selection for certain period of time or, for example, until the earliest of the earlier numerical prize graphics have been removed from the display. It is also possible to control the process such that only one numeric prize graphic may be displayed at a time by making the activation icons inactive for certain period of time after a numerical prize graphic has been displayed. Also, an activation selection input selecting one of the activation selection icons (such as 522-01 in FIG. 6) may cause the gaming machine to remove the previously displayed numerical prize graphic from the display substantially in the time required for that the numeric prize graphic for that next activation selection input to be displayed. In some implementations of the invention, the speed at which activation selection inputs may be received and/or the speed at which the numerical prize graphic is displayed in response to an activation selection input may be modified dynamically over the course of play as desirable. For example, such dynamic modification may be desirable to divert a player's attention momentarily to a promotional display at the gaming machine at some point in the course of play.

In implementations in which there is some overlap between the display of numerical prize graphics for different activation selection inputs, steps may be taken to prevent player or spectator confusion as to which numerical prize graphic is associated with which player selection input. For example, as shown in FIG. 6, the numerical prize graphic produced in response to the selection of a given activation selection icon may only be shown in the location of the display area 514 where that selected activation icon had been located at the time of the selection. This would be in contrast to an implementation where the numerical prize graphic is displayed at a location in the display (600 in FIG. 6) different from the location of the selected activation selection icon, perhaps at a window or region of the display dedicated for showing the respective numerical prize graphic after the selection of a given activation selection icon. As an additional example to avoid confusion between numerical prize graphics displayed concurrently in a given display, one or more graphic aspects of a numerical prize graphic may be changed in response to the receipt of the next or a subsequent activation selection input. For example, implementations of in accordance with the invention may remove any textual label such as the label “WON” 604 in FIG. 6 in response to receipt of the next activation selection input. As other examples, the numerical prize graphic (602 in FIG. 6) may be caused to change color in response to receipt of the next activation selection input and/or the gaming machine may cause the numerical prize graphic to begin fade in response to receipt of the next activation selection input.

In the example implementation shown in FIGS. 5 and 6, when a numerical prize graphic such as 602 in FIG. 6 is removed from the display (as at time T₅ in FIG. 7) the activation icon display area 514 may show a vacant area at that location for a period of time. This may result in apparent gaps in the activation icons presented in a given display. For example, FIG. 5 shows a vacant area directly above activation icon 522-01 that may have accommodated one or more activation icons that have been selected to show a result for the activation (either a numerical prize graphic or a losing result graphic) that was subsequently removed from the display. Similarly, the vacant area directly below activation icon 522-05 in display 500 may have accommodated one or more activation icons that have been selected to show a result for the activation that was subsequently removed from the display. Comparing FIGS. 5 and 6, it is apparent that display 600 in FIG. 6 has been modified to display an additional activation icon 522-25 in the area shown as vacant above activation icon 522-01 in FIG. 5. Such modifications to the display may be part of the display update process shown at 422 in FIG. 4.

As indicated in the example process shown in FIG. 4, in some cases it may be desirable to require more than one input in order to place an activation in the game. One such case is where activation icons are available with very high activation values such as the 10,000 credit activation shown at activation icon 522-04 in FIG. 5. FIGS. 8 and 9 show an example arrangement in which two separate inputs are required in order to place an activation according to the invention. FIG. 8 shows an activation icon 800 associated aid with an activation value of 10,000 credits indicated by label 802. This example activation icon 800 also includes a visual indicator 804 comprising a keyhole that may be defined as a locked indicator showing that this particular activation icon requires multiple selection inputs in order to place the high-value, 10,000 credit activation. In one implementation, touching activation icon 800 shown in FIG. 8 (a first player interaction with the activation icon) causes the icon to change to the condition shown in FIG. 9 in which the keyhole-locked visual indicator 804 is removed and a textual element 806 is shown indicating that the activation icon is unlocked and the activation of 10,000 credits associated with activation icon 800 may be placed by touching the modified icon (a second player interaction with the activation icon). Thus the arrangement indicated in FIGS. 8 and 9 requires two separate inputs/player interactions to place the high-value 10,000 credit activation. If the second player interaction is not received within a certain period of time after the first player interaction, the state of the activation icon 800 may revert back to the locked stated shown in FIG. 8. In any event, the arrangement requiring multiple player interactions with a given activation selection icon may prevent a player from inadvertently placing a high-value activation.

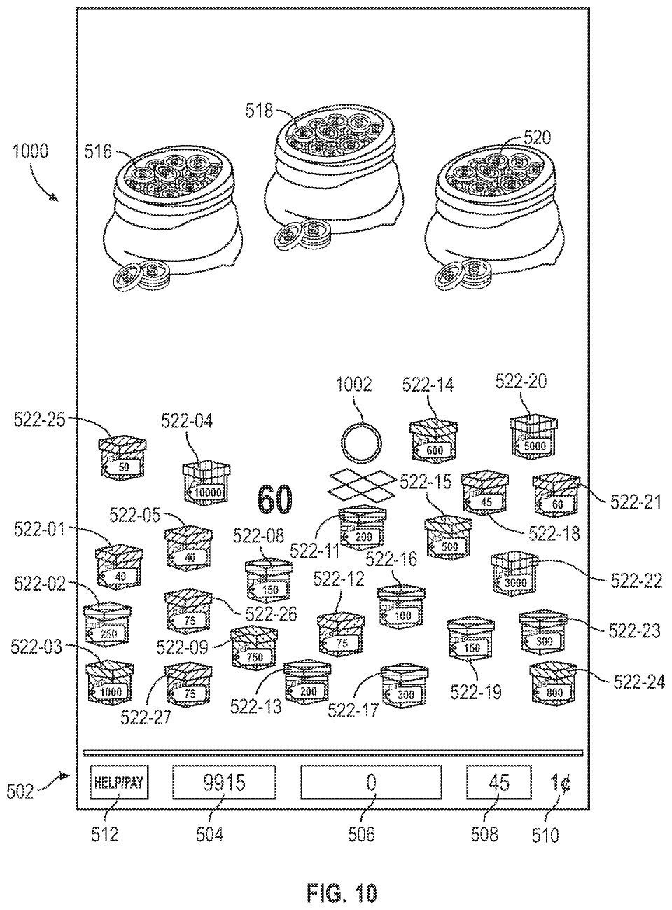

FIG. 10 shows a display 1000 that has resulted from proceeding through process blocks 406 through 424 multiple times after the point in time shown in FIG. 6. Changes in display 1000 relative to display 600 in FIG. 6 include the additional activation icons 522-26 and 522-27 added in the vacant area below activation icon 522-05 in FIG. 6 as the activation icons are updated as shown at 422 in FIG. 4. Also, it is apparent from FIG. 10 that the activation icon 522-07 shown in FIG. 5 and selected to result in display 600 in FIG. 6, has since been replaced by another activation icon associated with some activation value and an activation selection input has been received (at 406 in FIG. 4) by the selection of that activation icon. FIG. 10 shows a numerical prize graphic having static numerical value to show a 60-credit prize as a result of the selection of the activation icon previously displayed at that location. It is noted that this numerical prize graphic appears to be fading at this point and any textual label such as the label “WON” has been removed from the display. It is further apparent from comparing FIGS. 6 and 10 that the activation icon 522-06 in FIG. 6 has been selected and the result displayed at that location has since been changed to leave a vacant area ready to be repopulated with a new activation icon in accordance with the activation icon update process (such as shown at 422 in FIG. 4). Also in display 1000 shown in FIG. 10, activation icon 522-10 (shown in FIGS. 5 and 6 and being associated with a 45 credit activation) has been selected to display an object, in this case a coin 1002. Although no prize win is shown for this activation, the object 1002 may be shown to move up to one of the money-bag graphic elements 516, 518, or 520 at the top of display 1000. This interaction with the money-bag elements 516, 518, and 520 may start some bonus game available at the gaming machine for which some prize may be awarded. Alternatively, the interaction with the money-bag elements 516, 518, and 520 may randomly initiate a bonus game available at the gaming machine. In either case, the implementation illustrated in FIG. 10 provides the bonus game feature as an alternative to (or in addition to) showing at least part of the result of an activation via a numerical prize graphic. Thus the bonus game feature may be used to provide a more varied gaming experience.

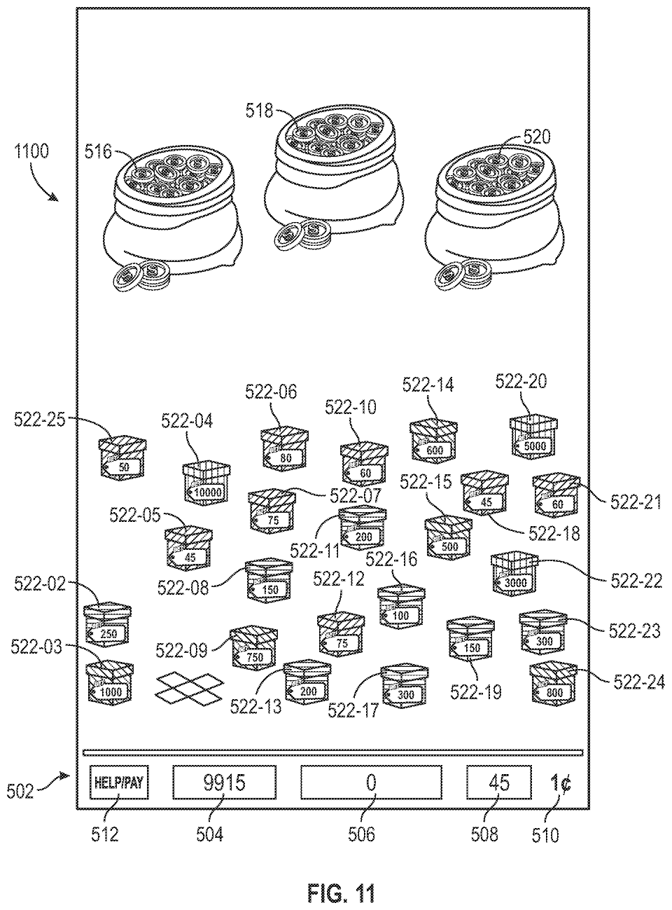

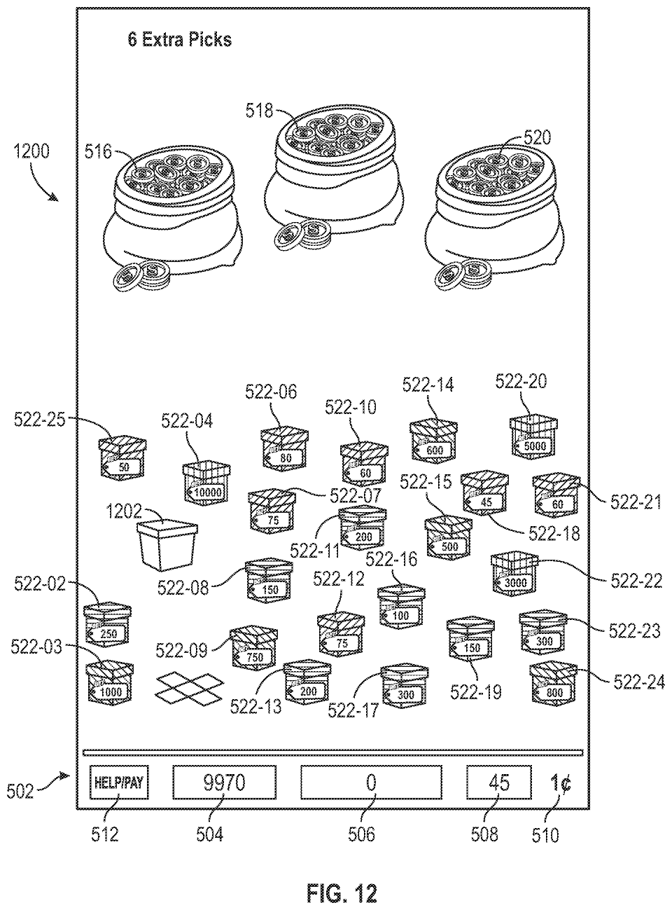

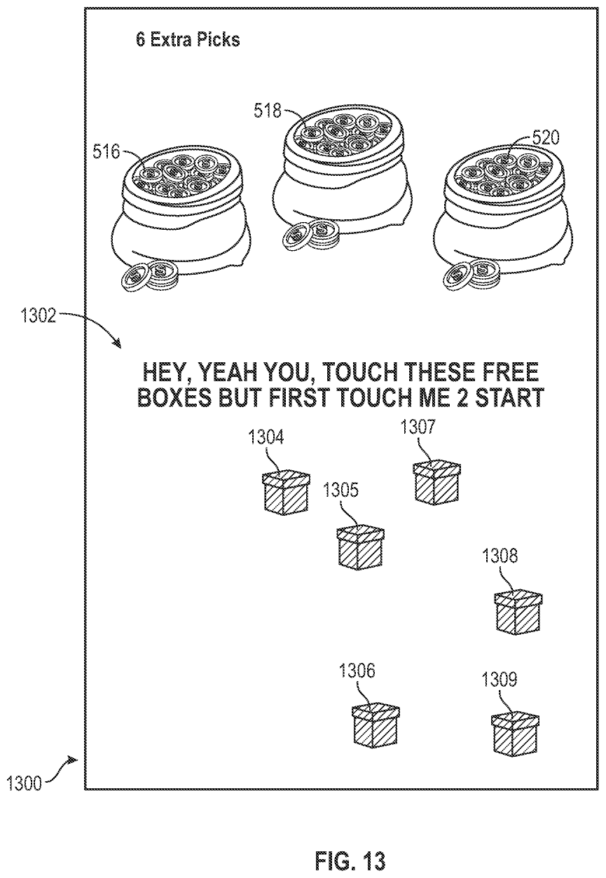

FIGS. 11 through 13 may be used to describe another feature that may be included in implementations of the present invention to vary the player's gaming experience. FIG. 11 shows a display 1100 in a state similar to that shown in FIG. 5. From the state shown in FIG. 11, activation icon 522-05 may be selected to result in the display 1200 shown in FIG. 12. In this implementation of the invention, the activation icon 522-05 does not open to show a numerical prize value but instead expands to show a larger box 1202 from which additional boxes 1304-1309 spring onto display 1300 as shown in FIG. 13. In this case all of the other activation icons (activation icon 522-01 for example) shown in FIGS. 11 and 12 have been dimmed in display 1300 to indicate they are not available for selection by the player until completion of the multi-box feature. The example of FIG. 13 also shows that a textual instruction 1302 has been added in display 1300 with instructions to the player for interacting with the additional boxes 1304-1309 that have been added. In this implementation, player simply selects each of these boxes in some fashion to provide an input for each box. Upon receipt of each input the respective box will open to show either no prize value or a prize value to be awarded for the activation made by selecting activation icon 522-05 in FIG. 11. Once an input has been received for each of the boxes 1304-1309, the player the sum of the numerical values shown from opening the six boxes represents the total prize for the activation made by selecting activation icon 522-05 in FIG. 11. In alternative arrangements, the prize values shown by the opened boxes 1304-1309 may be combined in some other fashion such as by multiplication or some other numerical operation or combination of operations to show the total prize amount. It should be noted that the six boxes 1304-1309 shown in display 1300 in FIG. 13 do not show any associated activation value. In this example, the activation for the play was placed by selecting activation icon 522-05 in FIG. 11 and no additional activation is required for opening the six boxes to reveal the prize resulting from the activation associated with activation icon 522-05. The arrangement shown in FIGS. 11 through 13 may be employed periodically in the course of play at the gaming machine in order to vary the player's experience over the course of play and help maintain the players interest in the game. The feature may also be used periodically to slow the rate at which activations are being placed at the gaming machine.

Numerous variations are possible on the feature shown for example in FIGS. 11-13. For example, rather than requiring a player interaction to open boxes 1304-1309 to reveal the prize values, the gaming machine may be configured to show the boxes opening automatically either one-by-one or simultaneously. This automatic opening may also be used in the event the player fails to make selections within a certain time. Also, in some implementations the player may be prompted to select a number of the boxes less than the total number of boxes (e.g., 1304-1309) shown on the display.

FIG. 14 comprises a block diagram of software and data structures that may be employed to implement prize value presentation arrangements in accordance with aspects of the present invention. The block diagram of FIG. 14 shows an arrangement 1402 for generating a first random number, an arrangement 1404 for obtaining a result based on that first random number, and an arrangement 1406 for generating a second random number. The result from 1404 is used to select a result script set 1408 corresponding to that result and the second random number from 1406 is used to select a result script from the selected script set. Game engine 1410 is operable to execute the selected result script to control the gaming machine display system to display the randomly selected result for the given activation selection input using media assets 1412 from an arrangement for storing such assets.

For centralized gaming architectures, a device such as a central determinant server (305 in FIG. 3 for example) may comprise the random number generating arrangement 1402. In such a centralized gaming architecture, the gaming machine may request a random number in response to an input (as shown at 406 in FIG. 4), and the central determinant server may include a random number generator that communicates the first random number to the gaming machine in response to the request. In many Class III type gaming systems, the random number generating arrangement 1402 comprises a random number generator at the gaming machine itself. In either case the random number generator may be a hardware-based random number generator or other random number generator conforming to applicable regulations for both security and randomness.

The arrangement 1404 for selecting a result based on the random number from block 1402 may likewise reside at a centralized device such as a central determinant server in a centralized gaming architecture or at the gaming machine itself. In either case, the arrangement 1404 may select a result by using the first random number from 1402 to select from a pool of available results to produce a desired prize distribution and payout percentage. Thus the application of arrangements 1402 and 1404 represent a result generation or identification process for obtaining results as indicated at process block 412 in FIG. 4. Where the display of the numerical prize graphic (as at 418 in FIG. 4) is implemented as a standalone game, the result will be the prize value to be displayed/revealed via the numerical prize graphic (as shown at 602 in FIG. 6 for example). Where a bonus game presentation is included with showing either a losing result or a numerical prize value, the selected result has a possibility of including only the prize value to be displayed in accordance with the present invention (at 418 in FIG. 4) or both that prize value and an additional prize value to be shown for the bonus game. It is also possible in implementations including one or more bonus games in addition to the numerical prize graphic display described in connection with FIGS. 4-6, that a separate random number is generated to randomly select the result for the bonus game.

The second random number generating arrangement 1406 in FIG. 14 comprises any suitable arrangement for generating a second random number. Where the gaming machine includes the arrangement 1402 for generating the first random number, the arrangement 1406 may comprise the same random number generator used to generate the first random number. Regardless of which specific element in the system is used to generate the second random number, that second random number is used in this example implementation of FIG. 14 together with the result selected at 1404 to select a specific result script to display the result at the gaming machine. Specifically, the gaming machine uses the result from 1404 to select a result script set 1408 that includes result scripts to show that particular result, that is, the prize associated with that result. The gaming machine also uses the second random number from block 1406 to select a specific one of the result scripts in the selected result script set 1408. For example, if the result correlates to a prize of 200 credits, the set 1408 containing scripts showing a 200-credit prize for the given activation selection input is selected and the second random number is use to select one of these scripts. As another example, if the result correlates to a prize of 500 credits, the set 1408 containing scripts showing a total 500-credit prize for the given activation of the gaming machine is selected and the second random number is used to select one of these scripts. The given script selected from a set 1408 may show only the prize value revealed in accordance with the invention as shown in FIGS. 5 and 6 for example, or that prize value and a value associated with another portion of the game for that activation selection input. In the latter case for example, there may be no prize shown in a numerical prize graphic as described above (with reference to FIG. 6 for example) and the entire prize amount may be revealed to the player via a bonus game associated with one of the bonus game indicators 516, 518, and 520.

The specific script selected from the set 1408 for the prize to be awarded is then loaded to the game engine 1410 and executed to cause the display system to display the desired graphics. The game engine 1410 may, for example, include a JSON script engine. Regardless of the nature of game engine 1410, it may access media assets 1412 stored in the game software and use these media assets to cause the gaming machine display system to display the game result. The media assets 1412 may include data structures for driving the various graphic elements shown in displays according to the present invention.

In other implementations of a prize revealing arrangement according to the present invention, the result script sets may not be stored as indicated at 1408 in FIG. 14 and selected with a second random number by the arrangement shown at 1406. In these implementations, control signals to cause the gaming machine display system to generate the displays for revealing the prize value in accordance with the present invention may be generated in response to the random result selected at the arrangement 1404 in FIG. 14. In particular, the result selected at 1404 may include a prize value to be displayed/revealed in accordance with the present invention and the display control commands for controlling the display device(s) to reveal that prize value built according to a suitable process.

Regardless of whether control scripts are generated ahead of time and stored as shown in FIG. 14, or whether they are generated “on-the-fly” in response to the result selected at 1404 in FIG. 14, the control for the display devices may be built by the same process. That process may include first obtaining the result in terms of the prize value to be displayed as indicated at 412 in FIG. 4 (and shown in example display 600 in FIG. 6).

In implementations of the invention where the result for each activation is obtained via a lottery ticket or record set, first random number generator 1402 shown in FIG. 14 may be replaced by the lottery record selection system. The result dictated by the lottery record may then be used to select the corresponding result script set 1408 in FIG. 4, and a script may be randomly selected from that script set. A bingo gaming system could also be used in place of the first random number device 1402. Also, in either the lottery type system or bingo system, the result for the activation may also dictate a specific script without the need for a random number as generated at 1406 in FIG. 14.

It should also be noted that regardless of whether a random number generator is used to select the result to be displayed to the player as indicated in FIG. 14, or whether the result identification process relies on a lottery ticket set or a bingo gaming system, the result identification process may be specific to a given activation or to a given activation range. That is, each activation level or activation level range may employ a result identification process to produce a particular volatility and return to player that may be different from those characteristics at another activation level or at another activation level range. Also, a result obtained for selecting any of the activation icons may include a bonus portion associated with any of the bonus games or bonus prizes associated with bonus game indicators 516, 518, and 520. However, the probability of having a bonus portion associated with a given result may be varied depending upon the level of the activation icon. For example, bonus game indicator 520 in FIGS. 5, 6, and 10-13 may be associated with a high-value bonus game or bonus prize and the probability of reaching that bonus game or winning that bonus prize may be relatively higher for activation icons over a certain activation value.

FIG. 15 will now be referenced to describe an alternate display produced in accordance with an embodiment of the present invention to accept activations and reveal prize results. FIG. 15 shows a display 1500 that may be produced on a display device such as display device 104 shown in FIG. 1 of gaming machine 100. Display 1500 includes a player information section shown generally at 1502 similar to player information section 502 in FIGS. 5, 6, and 10-12. Example player information section 1502 includes a credit meter window 1504, win meter window 1506, denomination indicator/control 1510 and player control virtual button 1512 similar to the corresponding elements in FIGS. 5, 6, and 10-12. A separate virtual control 1512A is provided for changing the sound volume at the gaming machine. In the state shown in FIG. 15, display 1500 shows a credit value of 9597 credits at credit meter window 1504 and 0 credits at win meter window 1506, indicating a 0-credit result for the last activation placed at the gaming machine. Unlike the display 500 shown in FIG. 5, display 1500 includes a set of color-coded activation range controls including a first, second, and third wage range selection virtual buttons 1508A, 1508B, and 1508C, respectively. These activation range controls may be used to select an activation icon set to be shown in the display as will be described further below.

Beyond the player information section 1502, display 1500 includes a first activation icon area shown generally at 1514A, a second activation icon area 1514B, three bonus game indicators 1516, 1518, and 1520, and a progressive prize window 1521 showing the current value of a progressive prize available through the game presentation. The activation icon area 1514A includes a number of different activation icons 1522A. Similarly to the embodiment shown in FIG. 5, each activation icon 1522A is represented by a box (that is, an enclosure) together with a label that indicates an activation amount. However, in the embodiment of FIG. 15 all of the activation icons 1522A have the same purple color (represented by left diagonal hatching) which correlates to a first activation range, in this case including the activations of 40, 45, 50, 60, and 75 credits. Thus as compared to the embodiment of FIG. 5, the activation icons 1522A are all associated with an activation in a given range rather than different ranges (indicated by color) in the activation icon area. The separate activation icon area 1514B in the embodiment of FIG. 15 includes activation icons 1522B each associated with an activation in a different range, in this case the highest range including activations of $25, $50, $75, and $100 (2500, 5000, 7500, and 10000 credits, respectively, at the one cent denomination shown in the figure). All of the activation icons 1522B also have a distinctive activation range-correlated color represented in this example by vertical hatching.

In the example display 1500, the player may select the activation range to be displayed in activation icon area 1514A from different activation ranges available to the player.

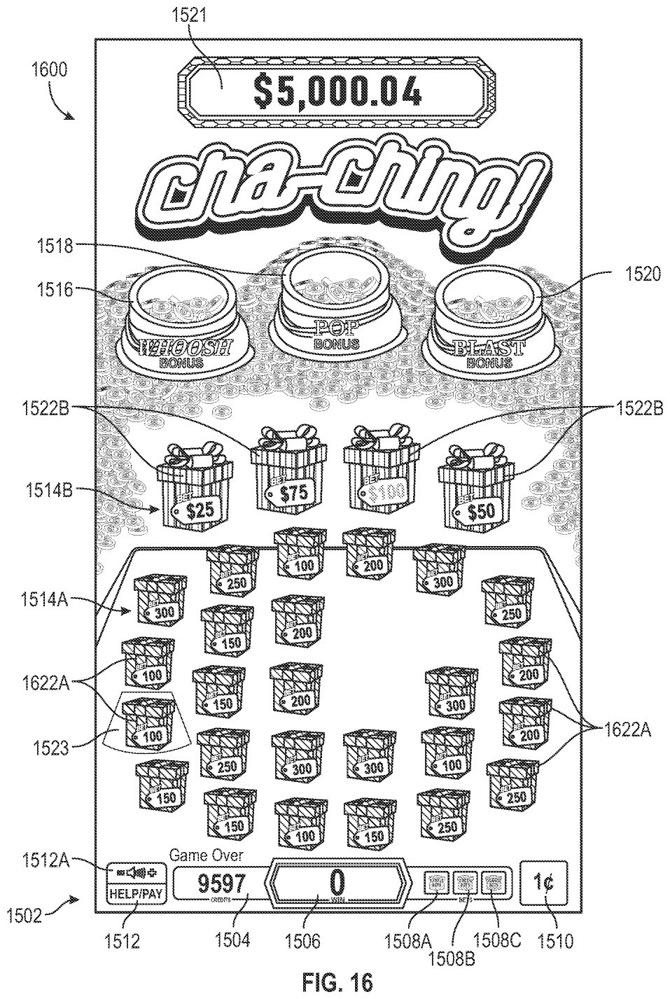

The activation range selection virtual buttons 1508A, 1508B, and 1508C may be used by the player to select a particular activation range to be displayed in activation icon area 1514A. In the condition shown in FIG. 15, the player may have activated activation range selection virtual button 1508A (with the corresponding purple color/left diagonal hatching) to cause the illustrated activation icons 1522A to be displayed. In this example, two other activation ranges are available for display in activation icon area 1514A, one activation range associated with the green virtual button 1508B (with the green color represented by right diagonal hatching) and the other associated with the orange virtual button 1508C (with the orange color represented by horizontal hatching). The example display 1600 shown in FIG. 16 illustrates a state of the game in this embodiment in which the player has activated virtual button 1508B to cause the activation icons of a second activation range to be displayed in activation icon area 1514A. This second activation range includes activations of 100, 150, 200, 250, and 300 credits, with the activation range indicated to the corresponding green color for each box included in a respective activation icon 1622A.

It will be noted in both FIGS. 15 and 16 that the $100 activation icon 1522B is shaded out as compared to the other activation icons in the displays. This shaded out condition indicates to the player that the activation is not available to the player because the player does not have sufficient credits shown in credit meter window 1504 to cover the activation. Any activation icon associated with an activation that is higher than the player's current credit meter amount shown in window 1504 may similarly be shaded out or otherwise graphically changed or perhaps removed from the display entirely to indicate that the activation is not then available to the player.

The example displays shown in FIGS. 15 and 16 show a distinctive graphic effect 1523 associated with a particular one of the activation icons 1522A and 1622A included in the respective display. This graphic effect may be generated in response to a player selection of the respective activation icon in the moment prior to the time any prize for the activation is displayed (displayed as described above in connection with FIGS. 6 and 7). The graphic effect 1523 may alternatively be produced essentially or apparently randomly for different activation icons over time to highlight those icons available for selection by the player.

The example displays shown in FIGS. 15 and 16 also both show that the activation icon area 1514A in each display includes an open area where no activation icons 1522A or 1622A are located. These open areas unoccupied by any activation icon may represent areas where previously selected activation icons were located and remain unreplaced by additional activation icons. These areas may eventually be filled with new activation icons in the selected activation range. In some implementations, an activation icon being added to fill a location in activation icon area 1514A may fade in to the location over some period of time to provide a smooth graphic effect, or alternatively appear to pop suddenly into the location with or without additional graphic effects to alert the player to the added activation icon.

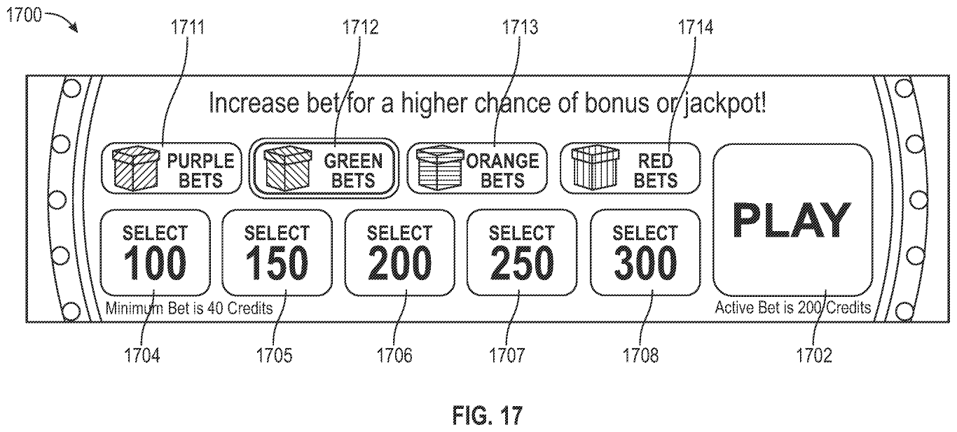

As with the example in FIG. 5, each of the activation icons 1522A and 1522B shown in the display 1500 represents a control that may be selected to place an activation at the activation value indicated by that activation icon. Also similarly to the example of FIG. 5, simply touching or otherwise selecting a respective activation icon (via a cursor and cursor control arrangement for example) may place the activation value associated with that activation icon as an activation for a play in the gaming machine. However, the examples shown in FIGS. 15 and 16 may provide an addition path for the player to make an activation in addition to touching or otherwise selecting one of the activation icons 1522A, 1522B, and 1622A. This additional path may be provided via a button panel 1700 shown in FIG. 17. This button panel 1700 may be implemented with a touch-screen video display such as touch-screen button panel 106 shown in FIG. 1 or some other touch-screen panel or mechanical button panel of the gaming machine. Example button panel 1700 includes a play button 1702 and number of activation select buttons 1704, 1705, 1706, 1707, and 1708 each associated with an activation amount corresponding to one of the activation amounts for the activation range in effect at the time in a display such as 1500 or 1600 in FIGS. 15 and 16, respectively. Button panel 1700 also includes a number of activation range selection button 1711, 1712, 1713, and 1714, each associated with a respective one of the activation ranges available in the given implementation.

As an alternative to touching or otherwise directly selecting one of the activation icons such as activation icons 1622A in FIG. 16, the player may select the desired activation range using one of the buttons 1711-1714, then select the desired activation using the corresponding one of the buttons 1704-1708, and then activate the play button 1702 to place that desired activation. In these implementations, one of the activation icons shown in the activation icon area (1514A or B in FIG. 15 for example) is then selected in any suitable fashion (such as randomly) by the gaming machine and the selected icon is replaced with the numerical prize graphic for a winning result or a suitable losing result graphic for a losing result as described above. Once a given activation amount is placed, implementations of the button panel 1700 may allow the player to repeat the same activation amount simply by activating the play button 1702. A text indicator of that “active” bet level may appear below the play button 1702 or elsewhere to indicate the activation amount that will be placed if the player activates the play button 1702. The example of FIG. 17 shows a text label “Active Bet Is 200 Credits” for this purpose. Otherwise, if the player desires to place an activation at another activation amount shown in one of the displayed buttons 1704-1708, the player may activate that respective button with a touch, stylus, or some other activation method, and then activate the play button 1702. For example, if a player wanted to place a 100-credit bet using button panel 1700, they could activate the “Select 100” button at 1704 to change the active bet to 100 credits and then activate the play button 1702. If the player desires to place an activation in a different one of the available activation ranges, they would activate the corresponding button 1711-1714 for that range to change the buttons 1704-1708 to show that activation range. For example, if the player desired to place a 40-credit bet in the implementation of button panel 1700 with display 1500 in FIG. 15, the player would activate button 1711 “Purple Bets” to cause the buttons 1704-1708 to show 40, 45, 50, 60, and 75 credits respectively and to cause the activation icon area 1514A to be populated with activation icons in this range (the range shown in FIG. 15). The player may then activate the 40-credit button from among buttons 1704-1708 as modified to the purple bet range, and then activate the play button 1702 to place the activation. In response to this activation, one of the 40-credit activation icons shown in area 1514A will be replaced with the appropriate result graphic corresponding to the result selected for that activation (at 412 in FIG. 4 for example). Thus the button panel 1700 provides a path to activating the gaming machine in an implementation of the invention as shown in FIG. 15 as an alternative to simply selecting (activating) one of the activation icons in activation icon areas 1514A or B. Also, aside from actually activating the gaming machine through button panel 1700, the button panel allows the player to change the range of activation icons shown in activation icon area 1514A using buttons 1711-1713 rather than buttons 1508A-C shown in FIGS. 15 and 16.

It should be noted that in implementations as shown in FIGS. 15 and 16 in connection with button panel 1700, the “Red Bets” (vertical hatching) associated with button 1714 may always be present in activation icon area 1514B regardless of which activation range is shown in activation icon area 1514A. Alternatively, implementations may show the high-level “Red Bets” in activation icon area 1514B only if the player selects those activation amounts to be active in some fashion (such as with some control (not shown) included on the display 1500 or 1600 or on button panel 1700).

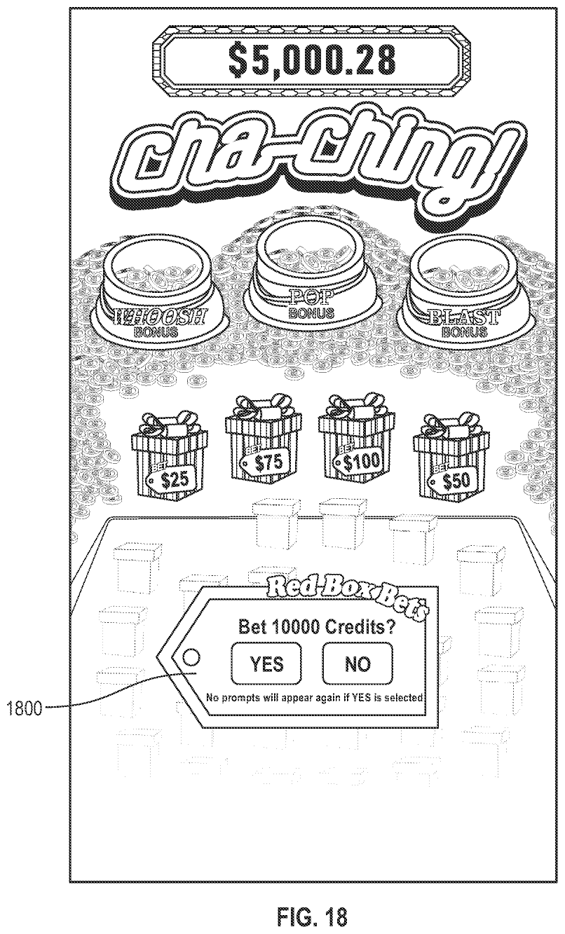

FIG. 18 shows an alternate arrangement for requiring two separate player interactions with the player input system to place a bet at one of the high activation levels available via activation icons 1522B in FIGS. 15 and 16. In this example, the player having sufficient available credit at the gaming machine has selected (activated) the $100 activation icon which equates to 10000 credits at a denomination of one cent. In response to this selection (first interaction), the processing system associated with the gaming machine causes the display device to display activation amount notice graphic 1800. The player must then select the “yes” virtual button of graphic 1800 (representing a second player interaction) in order to place the $100, 10000-credit activation.

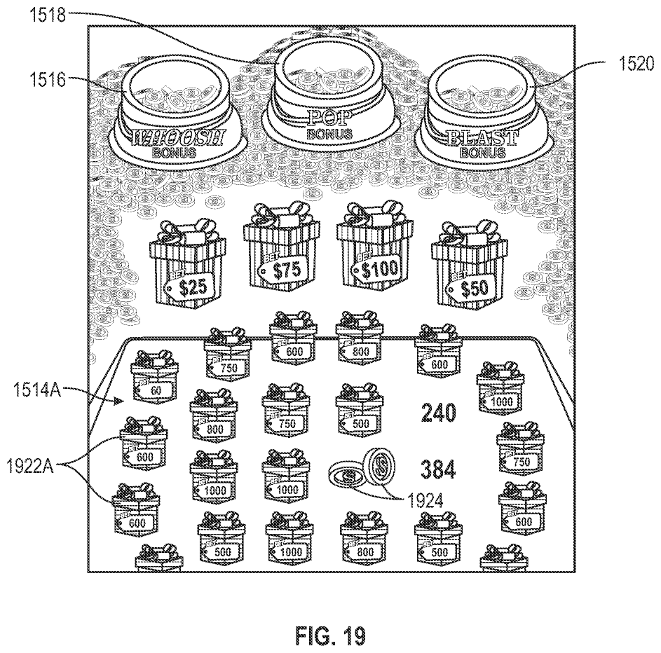

FIG. 19 shows a portion of a display similar to display 1500 in FIG. 15, but with the higher (“Orange Bets” from FIG. 17) selected and displayed via activation icons 1922A in activation icon area 1514A. The state of the display shown in FIG. 19 includes two prizes won in earlier activations of the game by selecting activation icons 1922A. These prizes of 240 credits and 384 credits are each in a state of fading out and thus removed from the display as described above particularly in connection with FIG. 7. The most recent selection of an activation icon 1922A has not revealed any numerical prize graphic, but rather coin symbols 1924 which move up to one or more of the bonus game indicators 1516, 1518, and 1520. Any of these bonus games may then be conducted as described above. It should be noted that higher activation values placed in the game via activation icons in activation icon area 1514A may generate more coins such as coins 1924 which move up to the money bag bonus game indicators 1516, 1518, and 1520 and/or provide a higher probability that one or more of the bonus games will be triggered or will be used to display a portion of a prize already selected for the given activation placed in the game.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of various embodiments, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A method including:
(a) under control of a display control processing system associated with a gaming machine, causing a video display system of the gaming machine to display a number of activation icons, each activation icon being associated with a respective activation value so that the number of activation icons define an activation value range from a minimum activation value to a maximum activation value, the maximum activation value being greater than the minimum activation value;
(b) receiving an activation selection input at the gaming machine through a player input system of the gaming machine, the activation selection input selecting one of the number of activation icons;
(c) in response to the activation selection input and under control of a result generating processing system associated with the gaming machine, obtaining a result for the activation selection input, the result for the activation selection input being identified according to a result identification process corresponding to the activation value defined by the received activation selection input; and
(d) where the result for the activation selection input comprises a winning result, causing the video display system of the gaming machine to display the result obtained for the activation selection input in a numerical prize graphic comprising a static numerical value, the video display system of the gaming machine displaying the numerical prize graphic under control of the display control processing system.

2. The method of claim 1 wherein the number of activation icons are displayed on a primary display device of the video display system and the numerical prize graphic is displayed on the primary display device of the video display system.

3. The method of claim 1 wherein the activation icon selected by the received activation selection input comprises a representation of an exterior of an enclosure and the numerical prize graphic includes a representation of opening the enclosure.

4. The method of claim 3 wherein the numerical prize graphic includes:
(a) an initial sequence comprising a representation of at least two additional enclosures in a closed state emerging from the opening of the enclosure; and
(b) a value display sequence following the initial sequence, the value display sequence comprising a representation of each of the additional enclosures opening to display a respective static numerical value for each of the additional enclosures.

5. The method of claim 1 wherein:
(a) the number of activation icons includes a first set of activation icons and a second set of activation icons;
(b) each activation icon of the first set of activation icons includes a respective activation value in a first activation range and each activation icon of the second set of activation icons includes a respective activation value in a second activation range that is non-overlapping with the first activation range;
(c) when the selected one of the number of activation icons is included in the first set of activation icons, the activation selection input consists of a single player interaction with the player input system of the gaming machine; and
(d) when the selected one of the number of activation icons is included in the second set of activation icons, the activation selection input consists of at least two player interactions with the player input system of the gaming machine.

6. The method of claim 5 wherein the at least two player interactions with the player input system includes:
(a) a first interaction comprising an activation icon designation input received from the player through the player input system to designate a respective one of the activation icons; and
(b) a second interaction comprising an activation icon confirmation input received from the player through the player input system to confirm the designated one of the activation icons.

7. The method of claim 6 further including:
(a) in response to the activation icon designation input the display control processing system causes an activation amount notice graphic to be displayed at the video display system; and
(b) wherein the activation icon confirmation input comprises an input from within the area of the activation amount notice graphic.

8. The method of claim 1 wherein:
(a) the number of activation icons includes a first set of activation icons and a second set of activation icons;
(b) each activation icon of the first set of activation icons includes a respective activation value in a first activation range and each activation icon of the second set of activation icons includes a respective activation value in a second activation range that is non-overlapping with the first activation range; and
(c) each activation icon of the first set of activation icons includes a first visual identifying characteristic separate from the respective activation value and each activation icon of the second set of activation icons includes a second visual identifying characteristic separate from the respective activation value, the first visual identifying characteristic being visually distinguished from the second visual identifying characteristic.

9. The method of claim 1 wherein:
(a) one or more of the activation icons are associated with a first predefined characteristic;
(b) one or more of the activation icons are associated with a second predefined characteristic different from the first predefined characteristic;
(c) where the activation selection input selects an activation icon associated with the first predefined characteristic, causing the video display system of the gaming machine to display the result obtained for the activation selection input in a graphic display having a first duration; and
(d) where the activation selection input selects an activation icon associated with the second predefined characteristic, causing the video display system of the gaming machine to display the result obtained for the activation selection input in a graphic display having a second duration different from the first duration.

10. A gaming machine including:
(a) a video display system;
(b) a player input system;
(c) at least one processor; and
(d) at least one memory device storing instructions executable by the at least one processor to:
(i) cause the video display system to display a number of activation icons, each activation icon including a respective activation value so that the number of activation icons define an activation value range from a minimum activation value to a maximum activation value, the maximum activation value being greater than the minimum activation value;
(ii) receive an activation selection input from the player input system, the activation selection input selecting one of the number of activation icons;
(iii) in response to the activation selection input, obtain a result for the activation selection input, the result for the activation selection input being identified according to a result identification process corresponding to the activation value defined by the received activation selection input; and
(iv) where the result for the activation selection input comprises a winning result, cause the video display system to display the result obtained for the activation selection input in a numerical prize graphic comprising a static numerical value.

11. The gaming machine of claim 10 wherein the number of activation icons are displayed on a primary display device of the video display system and the numerical prize graphic is displayed on the primary display device of the video display system.

12. The gaming machine of claim 10 wherein activation icon selected by the received activation selection input comprises a representation of an exterior of an enclosure and the numerical prize graphic includes a representation of opening the enclosure.

13. The gaming machine of claim 12 wherein the numerical prize graphic includes:
(a) an initial sequence comprising a representation of at least two additional enclosures in a closed state emerge from the opening of the enclosure; and
(b) a value display sequence following the initial sequence comprising a representation of each of the additional enclosures opening to display at least one respective static digit place for each of the additional enclosures.

14. The gaming machine of claim 10 wherein:
(a) the number of activation icons includes a first set of activation icons and a second set of activation icons;
(b) each activation icon of the first set of activation icons includes a respective activation value in a first activation range and each activation icon of the second set of activation icons includes a respective activation value in a second activation range that is non-overlapping with the first activation range;
(c) when the selected one of the number of activation icons is included in the first set of activation icons, the activation selection input consists of a single player interaction with the player input system of the gaming machine; and
(d) when the selected one of the number of activation icons is included in the second set of activation icons, the activation selection input consists of at least two player interactions with the player input system of the gaming machine.

15. The gaming machine of claim 14 wherein the at least two player interactions with the player input system include:
(a) a first interaction comprising an activation icon designation input received from the player through the player input system to designate a respective one of the activation icons; and
(b) a second interaction comprising an activation icon confirmation input received from the player through the player input system to confirm the designated one of the activation icons.

16. The gaming machine of claim 15 further including:
(a) in response to the activation icon designation input the at least one processor causes an activation amount notice graphic to be displayed at the video display system; and
(b) wherein the activation icon confirmation input comprises an input from within the area of the activation amount notice graphic.

17. The gaming machine of claim 10 wherein:
(a) the number of activation icons includes a first set of activation icons and a second set of activation icons;
(b) each activation icon of the first set of activation icons includes a respective activation value in a first activation range and each activation icon of the second set of activation icons includes a respective activation value in a second activation range that is non-overlapping with the first activation range; and
(c) each activation icon of the first set of activation icons includes a first visual identifying characteristic separate from the respective activation value and each activation icon of the second set of activation icons includes a second visual identifying characteristic separate from the respective activation value, the first visual identifying characteristic being visually distinguished from the second visual identifying characteristic.

18. The gaming machine of claim 10 wherein:
(a) the player input system includes an activation value range selector control operable to produce a value range selection input when activated; and
(b) the instructions are executable by the at least one processor to, in response to the value range selection input, cause the video display system to display a number of range-limited activation icons each associated with a respective activation value within a value range defined for the activation value range selector control.

19. A program product comprising one or more non-transitory computer readable data storage devices storing program code, the program code including:
(a) starting graphic program code executable by at least one processor to cause a video display system of a gaming machine to display a number of activation icons, each activation icon including a respective activation value so that the number of activation icons define a activation value range from a minimum activation value to a maximum activation value, the maximum activation value being greater than the minimum activation value;
(b) activation selection program code executable by the at least one processor to receive a activation selection input from a player input system of the gaming machine, the activation selection input selecting one of the number of activation icons;
(c) result assignment program code executable by the at least one processor to, in response to the activation selection input, obtain a result for the activation selection input, the result for the activation selection input being identified according to a result identification process corresponding to the activation value defined by the received activation selection input; and
(d) result display program code executable by the at least one processor to, where the result for the activation selection input comprises a winning result, cause the video display system to display the result obtained for the activation selection input in a numerical prize graphic comprising a static numerical value.

20. The program product of claim 19 wherein:
(a) the number of activation icons includes a first set of activation icons and a second set of activation icons;
(b) each activation icon of the first set of activation icons includes a respective activation value in a first activation range and each activation icon of the second set of activation icons includes a respective activation value in a second activation range that is non-overlapping with the first activation range;
(c) when the selected one of the number of activation icons is included in the first set of activation icons, the activation selection input consists of a single player interaction with the player input system of the gaming machine; and
(d) when the selected one of the number of activation icons is included in the second set of activation icons, the activation selection input consists of at least two player interactions with the player input system of the gaming machine, wherein the at least two player interactions with the player input system includes (i) a first interaction comprising a activation icon designation input received from the player through the player input system to designate a respective one of the activation icons, and (ii) a second interaction comprising a activation icon confirmation input received from the player through the player input system to confirm the designated one of the activation icons.
